(19) United States
(12) Patent Application Publication
(10) Pub. No.: US 2010/0211287 A1
(43) Pub. Date: Aug. 19, 2010

(54) INTERNAL COMBUSTION ENGINE CONTROL DEVICE

(76) Inventors: Kaoru Ohtsuka, Mishima-shi (JP); Hiroyuki Tanaka, Susono-shi (JP); Keisuke Kawai, Odawara-shi (JP); Shinichi Soejima, Gotenba-shi (JP)

Correspondence Address: OLIFF & BERRIDGE, PLC, P.O. BOX 320850, ALEXANDRIA, VA, 22320-4850, US

(21) Appl. No.: 12/738,933

(22) PCT Filed: Dec. 1, 2008
(86) PCT No.: PCT/JP2008/072214

§ 371 Date: Apr. 20, 2010

(30) Foreign Application Priority Data
Jan. 10, 2008 (JP) 2008-003000
Jan. 10, 2008 (JP) 2008-003001
Jan. 10, 2008 (JP) 2008-003002

(51) Int. Cl. F02D 28/00

(52) U.S. Cl. 701/102

(57) ABSTRACT

The internal combustion engine control device includes a request output section and a mediation section. The request output section expresses a plurality of requests about internal combustion engine functions (drivability, exhaust gas, and idling) in terms of physical quantities (torque, efficiency, and air-fuel ratio) and outputs the requests. The mediation section collects a plurality of requests A-C expressed in terms of the same physical quantity and conducts mediation in accordance with a predefined rule to determine one request value E. The requests A-C output from the request output section are defined on the basis of the range of request values and the distribution of expected values indicative of the degree of expectation of request values within the range. The mediation section calculates the sum D of the expected values of the plurality of requests A-C and conducts mediation to determine the request value E that prevails when the sum is maximized.

### TECHNICAL FIELD

The present invention relates to a control device for an internal combustion engine, and more particularly to a mediation process for mediating between a plurality of requests about internal combustion engine functions.

### BACKGROUND ART

A publicly known internal combustion engine control device disclosed in JP-A-2004-52769 determines one target value by mediating between a plurality of torque requests and other requests about internal combustion engine functions. This device generates one target torque for a vehicle drive unit from a plurality of torque requests that are output from a request generation source related, for instance, to drive slip control or driving dynamic performance control. The device predefines a priority order for a plurality of requests, and mediates between the requests on the basis of the predefined priority order to determine one target value.

To generate an appropriate target value in accordance with a plurality of requests, it is necessary to ensure that relatively high priority requests and relatively low priority requests are both reflected as appropriate in target value generation. However, the device disclosed in JP-A-2004-52769 often performs calculations to obtain a target value that is within the scope of the highest priority request, because it limits and shifts the target value in accordance with individual requests. Although the device disclosed in JP-A-2004-52769 takes all requests into consideration, it is possible that only relatively high priority requests will be reflected in target value generation while relatively low priority requests are left unreflected.

Further, the device disclosed in JP-A-2004-52769 merely predefines a priority order for each request and does not consider the importance of a request value of a request. A major request value (e.g., an effective request value) and a minor request value may exist within the scope of a request.

Furthermore, the device disclosed in JP-A-2004-52769 gives no consideration to an error that may occur between a control target value determined by mediation and an actual control result. Such an error may greatly reduce the degree of fulfillment of a plurality of requests output from the request generation source.

Moreover, when a plurality of operation modes such as a drivability priority mode, a fuel efficiency priority mode, and an exhaust emissions priority mode are available, the device disclosed in JP-A-2004-52769 may fail to acquire an optimum target value (mediation result) upon an operation mode change.

As described above, the device disclosed in JP-A-2004-52769 needs improvement to ensure proper request mediation.

### DISCLOSURE OF THE INVENTION

The present invention has been made in view of the above circumstances. An object of the present invention is to provide an internal combustion engine control device that is capable of causing a relatively low priority, minor request value and a relatively high priority, major request value to be reflected as appropriate in mediation when one target value is to be determined by mediating between a plurality of prioritized requests in order of importance.

The internal combustion engine control device according to the present invention includes request output means and mediation means. The request output means expresses a plurality of requests about internal combustion engine functions in terms of physical quantities, defines individual requests on the basis of the range of request values and the distribution of expected values indicative of the degree of expectation of request values within the range, and outputs the defined requests. The mediation means collects a plurality of requests that are output from the request output means and expressed in terms of the same physical quantity, and conducts mediation in accordance with the expected values of the requests to determine one request value.

A preferred mediation means calculates the sum of the expected values of the requests expressed in terms of the same physical quantity, and conducts mediation to determine a request value that prevails when the sum is maximized. The control device according to the present invention may include weight setup means for assigning weights to the requests output from the request output means. In such a case, the mediation means may calculate the sum of expected values that reflect the weights assigned by the weight setup means. When the requests are to be weighted, it is preferred that the requests be equal in the sum of expected values within the range of the associated request values. If, in such a case, the expected value of a request is greater than a predetermined upper limit value, it is preferred that the mediation means add the upper limit value instead of the expected value.

Further, when the requests are to be weighted, it is preferred that such weight setup be performed in accordance with a plurality of operation modes of an internal combustion engine. In such an instance, the mediation means may mediate between all the operation modes while considering the weight assigned to each operation mode. The control device according to the present invention may include gradual change means which, when a mode change is to be made from a first operation mode to a second operation mode, gradually changes the weight from a first weight defined for the first operation mode to a second weight defined for the second operation mode. In such an instance, the mediation means may conduct mediation while considering the weight changed by the gradual change means. Further, when a mode change is to be made from the first operation mode to the second operation mode, the necessity of performing a gradual change process may be determined in accordance with the comparison between the result of mediation conducted with consideration given to the first weight and the result of mediation conducted with consideration given to the second weight.

Another preferred mediation means calculates the sum of the expected values of the requests expressed in terms of the same physical quantity, determines specific points which are central points of a fixed range for making the amount of change in the sum within the fixed range not greater than a reference value, and conducts mediation to determine a request value that corresponds to the maximum specific point. Preferably, the above-mentioned fixed range is set in accordance with the type of physical quantity or in accordance with the type of physical quantity and the operating status of the internal combustion engine. More preferably, weights are assigned to the requests output from the request output means so that the mediation means calculates the sum of the expected values reflecting the assigned weights.

### BRIEF DESCRIPTION OF DRAWINGS

FIG. 1 is a block diagram illustrating the configuration of an internal combustion engine control device according to a first embodiment of the present invention.

FIG. 2 illustrates an efficiency request mediation process that an efficiency mediation element of a mediation section performs in accordance with the first embodiment of the present invention.

FIG. 3 illustrates an efficiency request mediation process that the efficiency mediation element of the mediation section performs in accordance with a second embodiment of the present invention.

FIG. 4 illustrates an efficiency request mediation process that the efficiency mediation element of the mediation section performs in accordance with a third embodiment of the present invention.

FIG. 5 is a block diagram illustrating the configuration of an internal combustion engine control device according to a fourth embodiment of the present invention.

FIG. 6 illustrates an efficiency request mediation process that the efficiency mediation element of the mediation section performs in accordance with the fourth embodiment of the present invention.

FIG. 7 shows typical weighting factors for various requests that the fourth embodiment of the present invention sets for various operation modes.

FIG. 8 is a flowchart illustrating a mediation process routine that the mediation section executes in accordance with the fourth embodiment of the present invention.

FIG. 9 is a first diagram illustrating an efficiency request mediation process that the efficiency mediation element of the mediation section performs in accordance with a fifth embodiment of the present invention.

FIG. 10 is a second diagram illustrating an efficiency request mediation process that the efficiency mediation element of the mediation section performs in accordance with the fifth embodiment of the present invention.

FIG. 11 is a flowchart illustrating a routine that the mediation section executes in accordance with the fifth embodiment of the present invention.

FIG. 12 relates to a sixth embodiment of the present invention, and shows fixed ranges R, which are calculated during mediation, and mediation results.

FIG. 13 is a flowchart illustrating a routine that the mediation section executes in accordance with the sixth embodiment of the present invention.

FIG. 14 relates to a seventh embodiment of the present invention, and shows fixed ranges R, which are set during mediation, and mediation results.

FIG. 15 is a flowchart illustrating a routine that the mediation section executes in accordance with the seventh embodiment of the present invention.

### BEST MODE FOR CARRYING OUT THE INVENTION

Embodiments of the present invention will now be described with reference to the accompanying drawings. Like elements in the drawings are designated by the same reference numerals and will not be redundantly described.

### First Embodiment

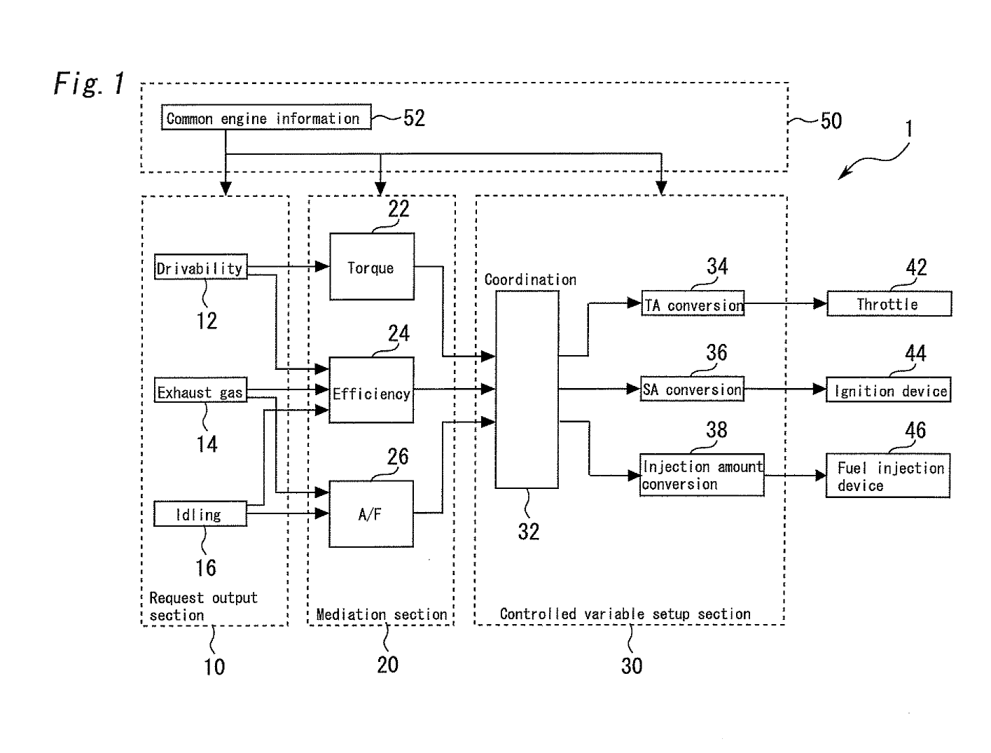

FIG. 1 is a block diagram illustrating the configuration of a control device 1 for an internal combustion engine according to a first embodiment of the present invention. As shown in FIG. 1, the control device 1 has three hierarchical levels 10, 20, 30. The highest hierarchical level is provided with a request output section 10. The hierarchical level immediately below the highest hierarchical level is provided with a mediation section 20. The lowest hierarchical level is provided with a controlled variable setup section 30. The controlled variable setup section 30 is connected to various actuators 42, 44, 46.

As indicated by arrows in FIG. 1, signals unidirectionally flow between the request output section 10, mediation section 20, and controlled variable setup section 30 of the control device 1. More specifically, the signals are transmitted from the request output section 10 to the mediation section 20 and from the mediation section 20 to the controlled variable setup section 30. The control device 1 also includes a common signal distribution section 50, which is independent of the above-mentioned hierarchical levels (request output section 10, mediation section 20, and controlled variable setup section 30). The common signal distribution section 50 is configured to parallelly distribute common signals to the request output section 10, mediation section 20, and controlled variable setup section 30.

Signals to be transmitted or distributed within the control device 1 will now be described.

A signal transmitted between the request output section 10, mediation section 20, and controlled variable setup section 30 represents a request about an engine function. Eventually, this signal is converted to controlled variables for the actuators 42, 44, 46.

On the other hand, a signal distributed by the common signal distribution section 50 contains information necessary for generating a request in the request output section 10 and computing a controlled variable in the controlled variable setup section 30. More specifically, this signal contains information about engine operating conditions and operating status (engine speed, intake air amount, estimated torque, current actual ignition timing, cooling water temperature, valve timing, operation mode, etc.). These items of information are obtained, for instance, by various sensors provided for the engine and an estimation function incorporated in the control device 1. These items of information constitute common engine information that is commonly used by all sections 10, 20, 30, and are distributed from a common engine information distribution section 52.

The request output section 10 shown in FIG. 1 digitizes a request about an engine function, and outputs the digitized request. The request output section 10 includes a plurality of request output elements 12, 14, 16. These request output elements 12, 14, 16 are provided for individual engine functions. The engine functions include those related, for instance, to drivability, exhaust gas, idling, fuel efficiency, noise, and vibration. As shown in FIG. 1, the request output element 12 (hereinafter also referred to as the “drivability request output element”) is provided for the function concerning drivability; the request output element 14 (hereinafter also referred to as the “exhaust gas request output element”) is provided for the function concerning exhaust gas; and the request output element 16 (hereinafter also referred to as the “idling request output element”) is provided for the function concerning idling.

An output generated from the engine includes not only torque but also heat and exhaust gas. The entire output determines the aforementioned various engine functions such as those related to drivability, exhaust gas, and idling. Therefore, parameters used for engine output control can be consolidated into three physical quantities: torque, efficiency, and air-fuel ratio. Efficiency will be described in detail later. When these three physical quantities are used to express a request and control the operations of the actuators 42, 44, 46, the request can be certainly reflected in the output of the engine. Thus, the first embodiment uses torque, efficiency, and air-fuel ratio (A/F) as the physical quantities to express requests.

The drivability request output element 12 outputs a request concerning drivability as a request expressed by torque (hereinafter referred to as a “torque request”) or as a request expressed by efficiency (hereinafter referred to as an “efficiency request”). The exhaust gas request output element 14 outputs a request concerning exhaust gas as an efficiency request or a request expressed by an air-fuel ratio (hereinafter referred to as an “air-fuel ratio request”). The idling request output element 16 outputs a request concerning idling as an efficiency request or air-fuel ratio request.

The common engine information distribution section 52 distributes common engine information to the request output section 10. The request output elements 12, 14, 16 reference the common engine information and determine (generate) the requests to be output. The reason is that the contents of a request vary with the engine's operating conditions and operating status. When, for instance, a catalyst temperature sensor (not shown) measures the catalyst temperature, the common engine information 52 includes the information about catalyst temperature. Therefore, the request output element 14 judges in accordance with the temperature information whether it is necessary to warm up a catalyst, and outputs an efficiency request and an air-fuel ratio request in accordance with the judgment result.

As described above, the request output section 10 outputs a plurality of torque requests, efficiency requests, and air-fuel ratio requests. However, all such requests cannot be completely fulfilled at the same time. Even when a plurality of torque requests are generated, only one torque can be achieved. Similarly, only one efficiency can be achieved even when a plurality of efficiency requests are generated; and only one air-fuel ratio can be achieved even when a plurality of air-fuel ratio requests are generated. It means that a request mediation process needs to be performed. More specifically, it is necessary to conduct mediation to consolidate a plurality of requests into one request value.

The mediation section 20, which is hierarchically lower than the request output section 10, mediates between the requests output from the request output section 10. As shown in FIG. 1, the mediation section 20 includes mediation elements 22, 24, 26, which are respectively related to the three different physical quantities (torque, efficiency, and air-fuel ratio) representing request categories. The torque mediation element 22 conducts mediation to consolidate a plurality of torque requests into one torque request value in accordance with a predetermined rule. The efficiency mediation element 24 conducts mediation to consolidate a plurality of efficiency requests into one efficiency request value in accordance with a predetermined rule. The air-fuel ratio mediation element 26 conducts mediation to consolidate a plurality of air-fuel ratio requests into one air-fuel ratio request value in accordance with a predetermined rule.

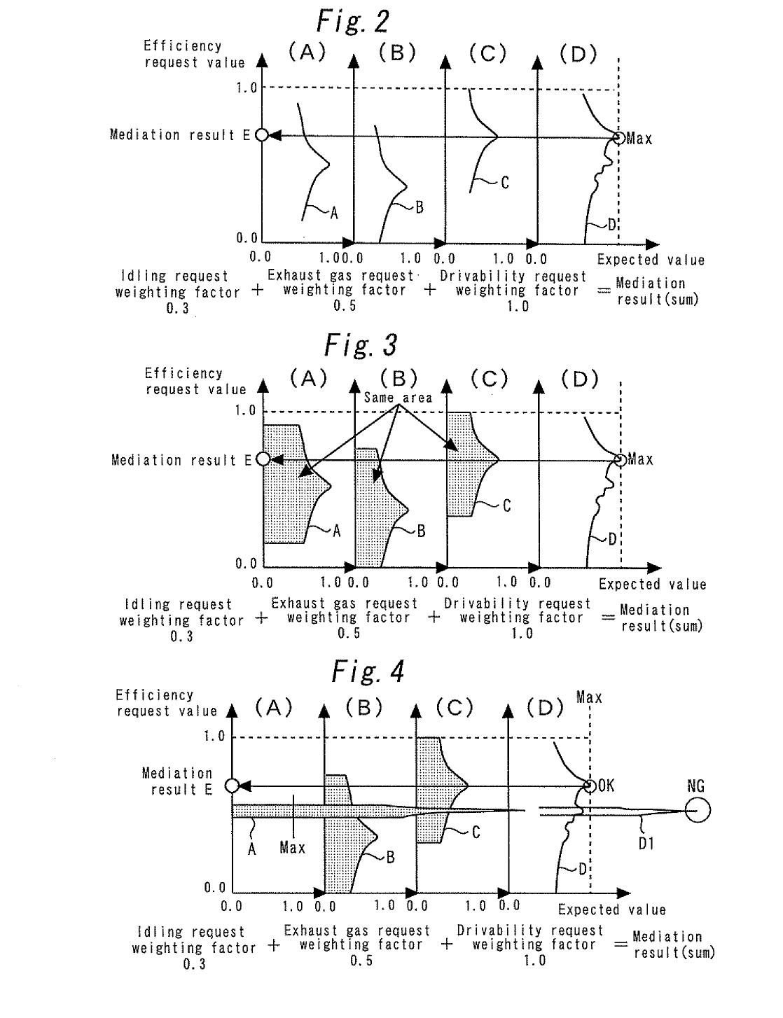

A typical efficiency request mediation process performed by the efficiency mediation element 24 of the mediation section 20 will now be described with reference to FIG. 2.

FIG. 2 illustrates an efficiency request mediation process that the efficiency mediation element 24 of the mediation section 20 performs in accordance with the first embodiment of the present invention. More specifically, section (A) of FIG. 2 shows an efficiency request A output from the idling request output element 16 (hereinafter referred to as an “idling efficiency request”); section (B) of FIG. 2 shows an efficiency request B output from the exhaust gas request output element 14 (hereinafter referred to as an “exhaust gas efficiency request”); section (C) of FIG. 2 shows an efficiency request C output from the drivability request output element 12 (hereinafter referred to as a “drivability efficiency request”); and section (D) of FIG. 2 shows the sum D of the efficiency requests A, B, C (i.e., a mediation result).

The efficiency requests A, B, C shown in FIG. 2 are defined on the basis of the range of request values and the distribution of expected values indicative of the degree of expectation of request values within the range. As regards the efficiency requests A, B, C, a request value having a great expected value is more important than a request value having a small expected value. Here, the term “range of request values” denotes a range of request values having an expected value greater than zero. It is a range within which a certain merit of internal combustion engine functionality (drivability, exhaust gas, or idling) can be obtained. Therefore, the merit derived from internal combustion engine functionality increases with an increase in the expected value of a request value.

Here, the term “efficiency” represents the ratio of current torque to a torque that is output when the MBT ignition timing is employed. The value of efficiency is not smaller than 0 and not greater than 1. Therefore, the efficiency request value is not smaller than 0 and not greater than 1. When an efficiency setting of smaller than 1 is employed, it is possible not only to instantly comply with a torque increase request by exercising control to advance the ignition timing, but also to instantly comply with a torque decrease request by exercising control to retard the ignition timing.

### [Idling Efficiency Request]

When the ignition timing is retarded from the MBT, combustion can be stabilized during idling. It is therefore preferred that the efficiency be lowered. It is also preferred that the efficiency be lowered during idling so as to rapidly increase the torque to avoid a stall when the engine speed drastically decreases due to disturbance. However, if the efficiency is excessively lowered, combustion may deteriorate. In view of these circumstances, the idling request output element 16 outputs an idling efficiency request A as indicated in section (A) of FIG. 2.

### [Exhaust Gas Efficiency Request]

For catalyst warm-up, it is preferred that the ignition timing be retarded to after-burn fuel for the purpose of raising the exhaust temperature. However, if the efficiency is excessively lowered, the catalyst temperature may excessively rise (OT). Further, an efficiency decrease request may be generated to suppress in-cylinder combustion for NOx reduction. In view of these circumstances, the exhaust gas request output element 14 outputs an exhaust gas efficiency request B as indicated in section (B) of FIG. 2.

### [Drivability Efficiency Request]

As regards drivability, it is infrequently demanded that a torque increase request be instantly complied with. As indicated in section (C) of FIG. 2, therefore, a drivability efficiency request C, which is output from the drivability request output element 12, generally exhibits a higher request value than the efficiency requests A, B shown in sections (A) and (B) of FIG. 2.

As shown in FIG. 1, these efficiency requests A-C are collected by the efficiency mediation element 24 of the mediation section 20. The efficiency mediation element 24 adds up the efficiency requests A-C. More specifically, the expected values of the efficiency requests A-C are added up within a request value range of 0 to 1. Weighting factors preselected for the efficiency requests A-C are reflected in the addition of the expected values. As shown in FIG. 2, the weighting factor setting is 0.3 for the idling efficiency request A, 0.5 for the exhaust gas efficiency request B, and 1.0 for the drivability efficiency request C. When values obtained by multiplying the expected values of the efficiency requests A-C by the weighting factors are added together, the sum D of the expected values is obtained as shown in section (D) of FIG. 2. Then, mediation is conducted to determine a request value E that prevails when the sum D of the expected values is maximized. More specifically, the efficiency request value E, which prevails when the sum D of the expected values is maximized, is selected as a mediation result and output from the efficiency mediation element 24.

The torque mediation element 22 and air-fuel ratio mediation element 26 perform the same process as described above although the detailed descriptions of concrete examples are omitted here. For example, the torque mediation element 22 collects a drivability torque request, which is output from the drivability request output element 12, and the other torque requests (pre-fuel-cut torque request, fuel cut recovery torque request, etc.), which are not shown, calculates the sum of the expected values of the requests in which the weighting factors are reflected, determines a torque request value that prevails when the sum is maximized, and selects the determined torque request value as a mediation result. For example, the air-fuel ratio mediation element 26 collects a drivability air-fuel ratio request and a fuel efficiency air-fuel ratio request, calculates the sum of the expected values of the requests in which the weighting factors are reflected, determines an air-fuel ratio request value that prevails when the sum is maximized, and selects the determined air-fuel ratio request value as a mediation result.

Meanwhile, the common engine information distribution section 52 distributes common engine information to the mediation section 20 as well. Although the common engine information is not used in the mediation process performed by the aforementioned efficiency mediation element 24, the mediation elements 22, 24, 26 can use the common engine information. For example, a mediation rule can be changed in accordance with the engine's operating conditions and operating status. However, the first embodiment does not change the rule in consideration of an engine's achievability range.

As is obvious from the above concrete example, the efficiency mediation element 24 conducts mediation without regard to upper and lower limits of the engine's achievability range and the mediation results produced by the other mediation elements 22, 26. The upper and lower limits of the engine's achievability range not only vary with the engine's operating conditions, but also vary with the relationship between torque, efficiency, and air-fuel ratio. Therefore, conducting mediation to place each request value within the engine's achievability range imposes an increased computational load on a computer. As such being the case, the mediation elements 22, 24, 26 conduct mediation by collecting only the requests output from the request output section 10.

When the mediation elements 22, 24, 26 perform the above mediation process, the mediation section 20 outputs one torque request value, one efficiency request value, and one air-fuel ratio request value. The controlled variable setup section 30, which is hierarchically lower than the mediation section 20, sets the controlled variables for the actuators 42, 44, 46 in accordance with the torque request value, efficiency request value, and air-fuel ratio request value, which constitute a mediation result.

The controlled variable setup section 30 includes one adjustment section 32 and a plurality of controlled variable computation elements 34, 36, 38. The controlled variable computation elements 34, 36, 38 are respectively provided for the actuators 42, 44, 46.

As shown in FIG. 1, the actuator 42 is a throttle and connected to the controlled variable computation element 34. This controlled variable computation element 34 computes a throttle opening TA as a controlled variable. The actuator 44 is an ignition device and connected to the controlled variable computation element 36. This controlled variable computation element 36 computes an ignition timing as a controlled variable. The actuator 46 is a fuel injection device and connected to the controlled variable computation element 38. This controlled variable computation element 38 computes a fuel injection amount as a controlled variable.

The coordination section 32 supplies numerical values that the controlled variable computation elements 34, 36, 38 use to compute controlled variables. First of all, the coordination section 32 adjusts the magnitudes of the torque request value, efficiency request value, and air-fuel ratio request value that are output from the mediation section 20. The reason is that the engine may fail to properly operate depending on the magnitudes of the request values because, as described earlier, the engine's achievability range is not taken into consideration when mediation is conducted in the request output section 10 and mediation section 20.

The coordination section 32 adjusts the request values in accordance with the interrelationship among them for the purpose of allowing the engine to operate properly. The request output section 10 and mediation section 20, which are hierarchically higher than the controlled variable setup section 30, compute the torque request value, efficiency request value, and air-fuel ratio request value independently of each other. The elements involved in computation do not use or reference a value computed by another element. In other words, the coordination section 32 is the first section that collectively references the torque request value, efficiency request value, and air-fuel ratio request value. When the controlled variable setup section 30 conducts coordination, the coordination target is limited to three request values, namely, the torque request value, efficiency request value, and air-fuel ratio request value. This reduces the computational load that is imposed on the adjustment section 32 when it conducts coordination.

The method of coordinating depends on the design employed. The present invention does not specifically define the coordination method. However, if the torque request value, efficiency request value, and air-fuel ratio request value are prioritized, it is preferred that a relatively low priority request value be adjusted (corrected). More specifically, a relatively high priority request value should be directly reflected in the controlled variables for the actuators 42, 44, 46, whereas a relatively low priority request value should be adjusted and reflected in the controlled variables for the actuators 42, 44, 46. This makes it possible to certainly fulfill a relatively high priority request and fulfill a relatively low priority request wherever possible within a range within which the engine can properly operate. When, for instance, the torque request value has the highest priority, the efficiency request value and air-fuel ratio request value should be corrected in such a manner that the lowest priority request value is corrected to a greater extent than the other. If the priority order varies, for instance, with the engine operating conditions, the priority order should be defined in accordance with the common engine information distributed from the common signal distribution section 50 to determine which request value is to be corrected.

As described above, the first embodiment of the present invention expresses requests about drivability, exhaust gas, and idling, which are related to engine functions, in terms of a physical quantity, namely, torque, efficiency, or air-fuel ratio, and causes the request output section 10 to output such a physical quantity. Individual requests are defined on the basis of the range of request values and the distribution of expected values indicative of the degree of expectation of request values within the range. The importance of each request value of a request can be expressed by the distribution of expected values.

The mediation section 20 then collects a plurality of requests expressed in terms of the same physical quantity, calculates the sum of the expected values of the plurality of requests, and conducts mediation to determine one request value that prevails when the sum is maximized. Thus, not only a request value of relatively high importance but also a request value of relatively low importance can be reflected in the sum. Therefore, a request value of relatively low importance can be reflected as appropriate in the mediation process. As a result, the mediation process can be properly performed.

Further, a weighting factor, which is taken into consideration during mediation, is set for each request output from the request output section 10. The mediation elements 22, 24, 26 calculate the sum of expected values that are multiplied by the weighting factor. This makes it possible to properly add up the expected values of a plurality of requests expressed in terms of the same physical quantity.

Furthermore, the controlled variables for the actuators 42, 44, 46 are computed in accordance with the torque request value, efficiency request value, and air-fuel ratio request value determined by mediation in the mediation section 20. This makes it possible to properly control the operations of the actuators 42, 44, 46 so that the requests are reflected in the output of the engine.

### Second Embodiment

A second embodiment of the present invention will now be described with reference to FIG. 3.

The first embodiment, which has been described above, sets a weighting factor for each request output from the request output section 10. To ensure that the weighting factor is properly reflected in the mediation process, it is necessary that individual requests be equally treated before the weighting factor is reflected.

The second embodiment outputs a plurality of requests A-C as shown in FIG. 3. FIG. 3 is a diagram illustrating an efficiency request mediation process performed by the efficiency mediation element 24 of the mediation section 20. More specifically, section (A) of FIG. 3 shows an idling efficiency request A; section (B) of FIG. 3 shows an exhaust gas efficiency request B; section (C) of FIG. 3 shows a drivability efficiency request C; and section (D) of FIG. 3 shows the sum D of the efficiency requests A, B, C (i.e., a mediation result).

The efficiency requests A-C shown in FIG. 3 are defined on the basis of the range of request values and the distribution of expected values indicative of the degree of expectation of request values within the range. Further, the efficiency requests A-C have the same area. In the second embodiment, the integrated values of the expected values of the efficiency requests A, B, C, namely, the sums of the expected values within the request value range of the efficiency requests A, B, C, are equalized. Therefore, the efficiency requests A, B, C are treated equally before multiplication by the weighting factors. This ensures that the weighting factors are properly reflected when the sums are calculated. Consequently, the mediation process can be properly performed.

### Third Embodiment

A third embodiment of the present invention will now be described with reference to FIG. 4.

The second embodiment, which has been described above, assumes that the efficiency requests A, B, C have the same area. However, the request value range may become significantly narrow depending on the operating status. If the request value range is significantly narrow, the expected values within such a request value range are significantly great. Then, the sum of such great expected values may become maximized. In such an instance, the weighting factors set for the requests may become meaningless.

When an expected value is greater than a predetermined upper limit value, the third embodiment adds the upper limit value instead of the expected value as shown in FIG. 4. FIG. 4 is a diagram illustrating an efficiency request mediation process that the efficiency mediation element 24 of the mediation section 20 performs in accordance with the third embodiment. More specifically, section (A) of FIG. 4 shows an idling efficiency request A; section (B) of FIG. 4 shows an exhaust gas efficiency request B; section (C) of FIG. 4 shows a drivability efficiency request C; and section (D) of FIG. 4 shows the sum D of the efficiency requests A, B, C (i.e., a mediation result).

When the request value range of the idling efficiency request A is significantly narrow as shown in section (A) of FIG. 4, the expected value becomes significantly greater than indicated in section (A) of FIG. 2 and section (A) of FIG. 3. If the sum is calculated by multiplying the expected value by a weighting factor, the sum forms a sharp peak in section (D) of FIG. 4 as indicated by the symbol D1. In this instance, a request value corresponding to the peak may be selected as a mediation result even if the expected value is multiplied by a small weighting factor. It means that improper mediation is conducted in such an instance.

When the expected value is greater than the predetermined upper limit value Max, the third embodiment uses the upper limit value Max instead of the expected value as shown in section (A) of FIG. 4. More specifically, the third embodiment calculates the sum by multiplying the upper limit value Max by a weighting factor. This prevents the expected value from exceeding the upper limit value Max. Therefore, the weighting factor can be properly reflected in the expected value.

Further, the areas of individual requests are equalized. Therefore, if the request value range is known, it is easy to determine whether the expected value exceeds the upper limit value Max. Consequently, when a mediation request value range is narrower than a reference value, the mediation elements 22, 24, 26 may use the upper limit value Max instead of the expected value.

### Fourth Embodiment

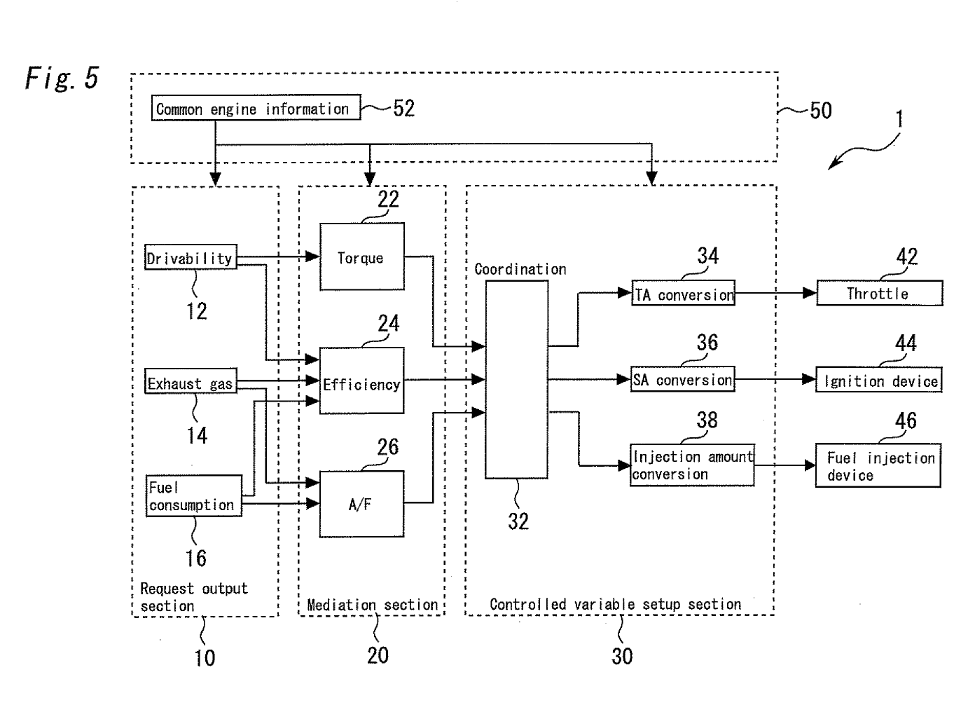

A fourth embodiment of the present invention will now be described with reference to FIGS. 5 to 8.

FIG. 5 is a block diagram illustrating the configuration of the control device 1 for an internal combustion engine according to the fourth embodiment of the present invention. In the fourth embodiment, the request output element 16, which is one of a plurality of request output elements 12, 14, 16 that serve as control sections or control modules for individual functions of the engine, is provided for a function related to fuel consumption. In the fourth embodiment, the request output element 16 is referred to as a fuel consumption request output element. The fuel consumption request output element 16 outputs a request related to fuel consumption as an efficiency request or an air-fuel ratio request.

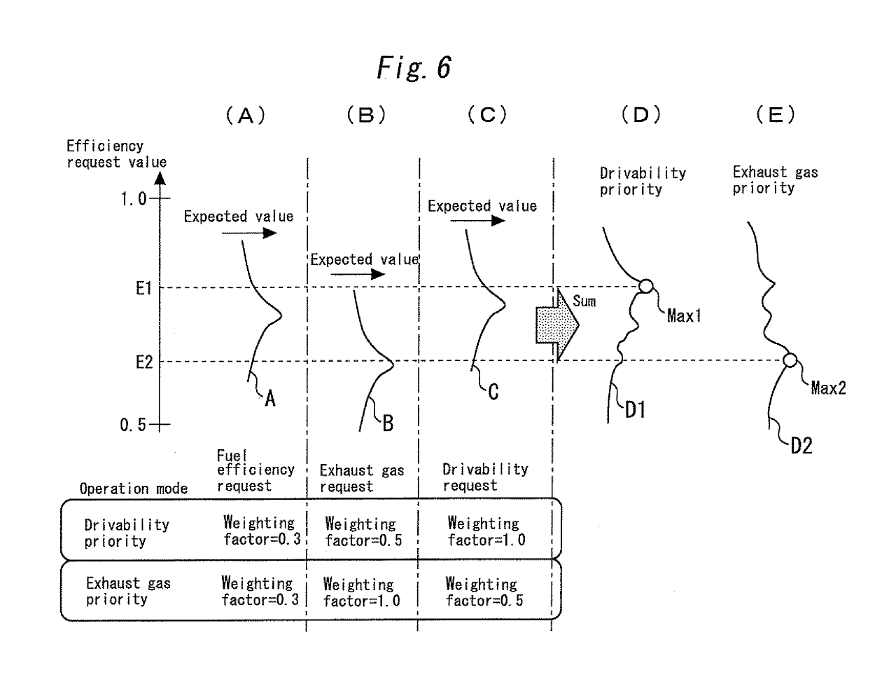

A typical mediation process that the mediation section 20 performs in accordance with the fourth embodiment, or more specifically, a typical efficiency mediation process that the efficiency mediation element 24 of the mediation section 20 performs, will now be described with reference to FIG. 6.

FIG. 6 is a diagram illustrating an efficiency mediation process that the efficiency mediation element 24 of the mediation section 20 performs in accordance with the fourth embodiment. More specifically, section (A) of FIG. 6 shows an efficiency request A output from the fuel consumption request output element 16 (hereinafter referred to as a “fuel efficiency request”); section (B) of FIG. 6 shows an efficiency request B output from the exhaust gas request output element 14 (hereinafter referred to as an “exhaust gas efficiency request”); and section (C) of FIG. 6 shows an efficiency request C output from the drivability request output element 12 (hereinafter referred to as a “drivability efficiency request”). Section (D) of FIG. 6 shows the sum D1 of the efficiency requests A, B, C when the selected operation mode is a drivability priority mode. Section (E) of FIG. 6 shows the sum D2 of the efficiency requests A, B, C when the selected operation mode is an exhaust gas priority mode.

The efficiency requests A-C shown in FIG. 6 are defined on the basis of the range of request values and the distribution of expected values indicative of the degree of expectation (degree of demand) of request values within the range. As regards the efficiency requests A-C, a request value having a great expected value is more important and characterized by a higher degree of demand than a request value having a small expected value. Here, the term “range of request values” denotes a range of request values having an expected value greater than zero. It is a range within which a certain merit of internal combustion engine functionality (drivability, exhaust gas, or fuel efficiency) can be obtained. Therefore, the merit derived from internal combustion engine functionality increases with an increase in the expected value of a request value.

### [Fuel Efficiency Request]

Combustion can be stabilized by retarding the ignition timing from the MBT. It is therefore preferred that the efficiency be lowered. However, if the efficiency is excessively lowered, combustion may deteriorate. In view of these circumstances, the fuel efficiency request output element 16 outputs a fuel efficiency request A as indicated in section (A) of FIG. 6.

### [Exhaust Gas Efficiency Request]

For catalyst warm-up, it is preferred that the ignition timing be retarded to after-burn fuel for the purpose of raising the exhaust temperature. However, if the efficiency is excessively lowered, the catalyst temperature may excessively rise (OT). Further, an efficiency decrease request may be generated to suppress in-cylinder combustion for NOx reduction. In view of these circumstances, the exhaust gas request output element 14 outputs an exhaust gas efficiency request B as indicated in section (B) of FIG. 6.

### [Drivability Efficiency Request]

As regards drivability, it is infrequently demanded that a torque increase request be instantly complied with. As indicated in section (C) of FIG. 6, therefore, the drivability efficiency request C, which is output from the drivability request output element 12, generally exhibits a higher request value than the efficiency requests A, B shown in sections (A) and (B) of FIG. 6.

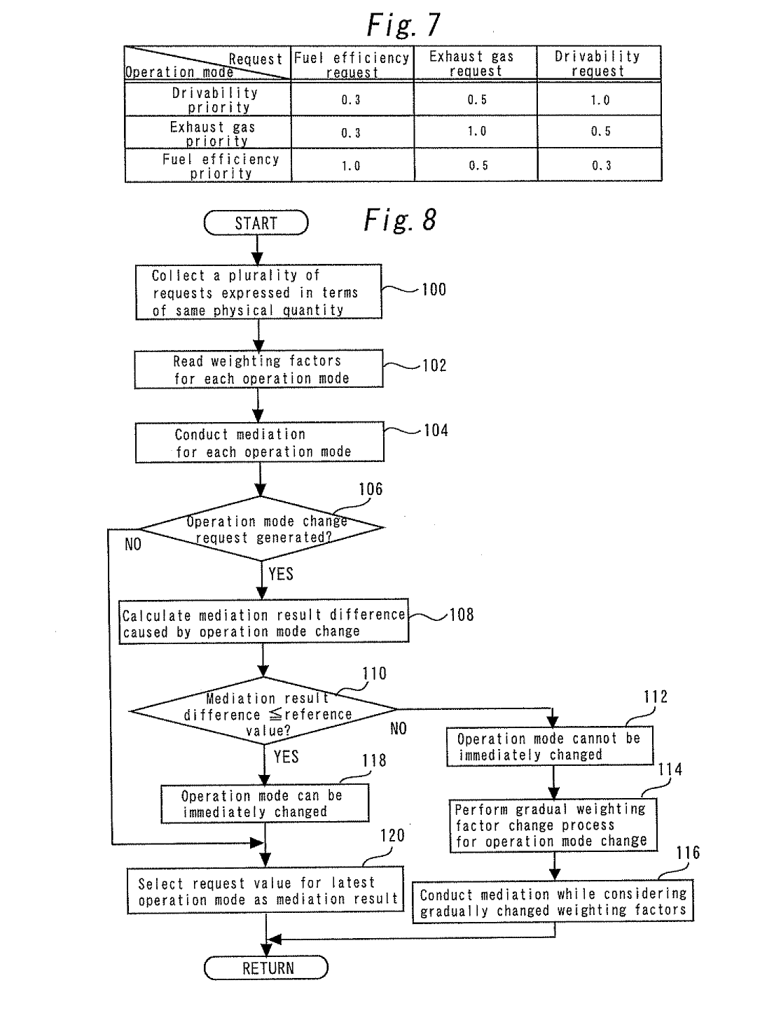

As shown in FIG. 5, these efficiency requests A-C are collected by the efficiency mediation element 24 of the mediation section 20. The efficiency mediation element 24 adds up the efficiency requests A-C. More specifically, the expected values of the efficiency requests A-C are added up within a request value range of 0 to 1. Weighting factors preselected for the efficiency requests A-C are reflected in the addition of the expected values. The weighting factors represent the priority between the efficiency requests A-C. As shown in FIG. 7, the weighting factors are set in accordance with the selected operation mode. FIG. 7 shows typical weighting factors that are set for various requests in accordance with the selected operation mode. The weighting factors set as shown in FIG. 7 are stored in the mediation section 20.

When, for instance, the selected operation mode is a drivability priority mode, the weighting factor setting is 0.3 for the fuel efficiency request A, 0.5 for the exhaust gas efficiency request B, and 1.0 for the drivability efficiency request C, as shown in FIG. 7. When values obtained by multiplying the expected values of the efficiency requests A-C by the weighting factors are added together, the sum D1 of the expected values is obtained as shown in section (D) of FIG. 6. Then, mediation is conducted to determine a request value E1 that prevails when the sum D1 of the expected values reaches its maximum Max1. More specifically, the efficiency request value E1, which prevails when the sum D1 of the expected values reaches its maximum Max1, is selected as a mediation result and output from the efficiency mediation element 24.

When, on the other hand, the selected operation mode is an exhaust gas priority mode, the weighting factor setting is 0.3 for the fuel efficiency request A, 1.0 for the exhaust gas efficiency request B, and 0.5 for the drivability efficiency request C, as shown in FIG. 7. When values obtained by multiplying the expected values of the efficiency requests A-C by the weighting factors are added together, the sum D2 of the expected values is obtained as shown in section (E) of FIG. 6. Then, mediation is conducted to determine an efficiency request value E2 that prevails when the sum D2 of the expected values reaches its maximum Max2. More specifically, the efficiency request value E2, which prevails when the sum D2 of the expected values reaches its maximum Max2, is selected as a mediation result and output from the efficiency mediation element 24.

As described above, a proper sum is acquired in accordance with the operation mode when the weighting factors are set for the requests A-C in accordance with the operation mode. Therefore, an optimum mediation result can be obtained. This also makes it possible to obtain an optimum mediation result even when the operation mode is changed.

It is conceivable that the mediation result may significantly change due to a weighting factor change at the time of an operation mode change. In such an instance, the engine status may suddenly change. Therefore, when a mediation result change brought about by an operation mode change is greater than a reference value, the weighting factors are gradually changed in a manner detailed later without immediately changing the operation mode. Then, mediation is conducted with consideration given to the gradually changed weighting factors. This makes it possible to prevent the engine status from changing suddenly due to an operation mode change.

The torque mediation element 22 and air-fuel ratio mediation element 26 perform the same process as described above although the detailed descriptions of concrete examples are omitted here. For example, the torque mediation element 22 collects a drivability torque request, which is output from the drivability request output element 12, and the other torque requests (pre-fuel-cut torque request, fuel cut recovery torque request, etc.), which are not shown, calculates the sum of the expected values of the requests with consideration given to the weighting factors set in accordance with the selected operation mode, determines a torque request value that prevails when the sum is maximized, and selects the determined torque request value as a mediation result. For example, the air-fuel ratio mediation element 26 collects a drivability air-fuel ratio request and a fuel efficiency air-fuel ratio request, calculates the sum of the expected values of the requests with consideration given to the weighting factors set in accordance with the selected operation mode, determines an air-fuel ratio request value that prevails when the sum is maximized, and selects the determined air-fuel ratio request value as a mediation result.

### [Details of Process Performed by Fourth Embodiment]

FIG. 8 is a flowchart illustrating a mediation process routine that the mediation section 20 executes in accordance with the fourth embodiment. The routine is started at predetermined time intervals.

First of all, the routine shown in FIG. 8 performs step 100 to collect a plurality of requests expressed in terms of the same physical quantity. In step 100, the mediation section 20 collects, for example, a fuel efficiency request A shown in section (A) of FIG. 6, an exhaust gas efficiency request B shown in section (B) of FIG. 6, and a drivability efficiency request C shown in section (C) of FIG. 6.

Next, step 102 is performed to read the weighting factors for each operation mode. For example, step 102 is performed to read the weighting factors that are preselected and stored for various requests in each operation mode as shown in FIG. 3. Step 104 is then performed to conduct mediation for each operation mode with consideration given to the weighting factors read in step 102. In step 104, mediation is conducted for all operation modes including the currently selected one.

For example, the sum D1 shown in section (D) of FIG. 6 is calculated for the drivability priority mode so that the efficiency request value E1 prevailing when the sum D1 is maximized is determined as a mediation result. At the same time, the sum D2 shown in section (E) of FIG. 6 is calculated for the exhaust gas priority mode so that the efficiency request value E2 prevailing when the sum D2 is maximized is determined as a mediation result. In addition, the efficiency request value prevailing when the sum is maximized is determined as a mediation result for the fuel efficiency priority mode although it is not shown in the figure.

Next, step 106 is performed to judge whether an operation mode change request is generated. As described earlier, the common engine information distributed from the common engine information distribution section 52 to the mediation section 20 includes an operation mode. If it is found in step 106 that the currently distributed latest operation mode differs from the last distributed operation mode, it is judged that an operation mode change request is generated.

If the judgment result obtained in step 106 indicates that no operation mode change request is generated, step 120, is performed to select a request value for the latest operation mode as a mediation result. When, for instance, the drivability priority mode is the latest operation mode, the efficiency request value E1 shown in FIG. 6 is selected as the current final mediation result. In step 104, which was described earlier, mediation was conducted for all operation modes. In step 120, therefore, the mediation result (request value) for the latest operation mode is acquired from among the plurality of mediation results (request values) obtained in step 104. Consequently, the mediation result can be instantly acquired. Subsequently, the routine terminates.

If, on the other hand, the judgment result obtained in step 106 indicates that an operation mode change request is generated, step 108 is performed to calculate a mediation result change (absolute value) brought about by an operation mode change. If, for instance, an operation mode change request is generated to switch from the drivability priority mode to the exhaust gas priority mode, step 108 is performed to calculate the difference (E1-E2) between the efficiency request values shown in FIG. 6 as an efficiency mediation result difference. Next, step 110 is performed to judge whether the mediation result difference calculated in step 108 is not greater than a reference value. Reference values are set individually for physical quantities (torque, efficiency, and air-fuel ratio) and stored beforehand in the mediation section 20. In step 110, a reference value corresponding to a specific physical quantity is read from among the stored reference values and used for the judgment process.

If the judgment result obtained in step 110 indicates that the mediation result difference is greater than the reference value, it is judged in step 112 that an operation mode change cannot be immediately made. More specifically, it is judged that an immediate operation mode change may cause a weighting factor change to significantly change the mediation result and adversely affect the status of the internal combustion engine 1. For example, a sudden increase in the efficiency request value may reduce the amount of torque increase provided by an advanced ignition timing and result in the failure to comply with a torque increase request. Further, for example, a sudden decrease in the efficiency request value may raise the exhaust temperature to unduly raise the catalyst bed temperature. Furthermore, if the air-fuel ratio request value suddenly changes from an air-fuel ratio request value near the stoichiometric value to a lean air-fuel ratio request value during stratified charge combustion, the controllability of air-fuel ratio decreases, which may cause an increased torque change or increase the likelihood of misfiring.

In the above instance, step 114 is performed to gradually change the weighting factors as appropriate for the intended operation mode change instead of immediately changing the operation mode or suddenly changing the weighting factors. In other words, a gradual weighting factor change process is performed in step 114. When, for instance, an operation mode change request is generated to switch from the drivability priority mode to the exhaust gas priority mode, step 114 is performed to gradually increase the weighting factor for the exhaust gas request from 0.5 and gradually decrease the weighting factor for the drivability request from 1.0 because the weighting factor for the fuel efficiency request remains unchanged (0.3). Step 116 is then performed to conduct mediation with consideration given to the weighting factors that were gradually changed in step 114 above. More specifically, step 116 is performed to calculate the sum with consideration given to the gradually changed weighting factors, determine a request value prevailing when the sum is maximized, and select the determined request value as the current final mediation result. Subsequently, the routine terminates.

When the routine starts later, all the above steps up to and including step 106 are sequentially performed. If the judgment result obtained in step 106 indicates that an operation mode change request is generated, step 108 is performed to calculate the difference between the mediation result for the operation mode prevailing after a mode change and the mediation result for the operation mode prevailing before the mode change, which is determined in step 116. In other words, the mediation result obtained with consideration given to the gradually changed weighting factors is used as the mediation result for the operation mode prevailing before the mode change. If it is found that the mediation result difference is not greater than the reference value, it is judged in step 118 that the operation mode can be immediately changed. More specifically, it is judged that a weighting factor change caused by an immediate operation mode change will scarcely produce an adverse effect on the status of the internal combustion engine 1. In this instance, step 120 is performed to select the request value for the latest operation mode as the mediation result. In other words, the mediation result for the latest operation mode is acquired from among the plurality of mediation results obtained in step 104. Subsequently, the routine terminates.

In the fourth embodiment, the weighting factors, which are taken into consideration when a plurality of requests expressed in terms of the same physical quantity are added up, are set in accordance with the selected operation mode as described above. Therefore, the weighting factors are changed when the operation mode is changed. This makes it possible to obtain an optimum mediation result.

Further, if the mediation result difference brought about by an operation mode change is greater than the reference value, the gradual weighting factor change process is performed instead of immediately changing the operation mode. When the gradual weighting factor change process is performed as described above at appropriate timing, it is possible to prevent the engine status from changing suddenly due to an operation mode change.

Furthermore, when the controlled variables for the individual actuators 42, 44, 46 are computed in accordance with the torque request value, efficiency request value, and air-fuel ratio request value determined by mediation in the mediation section 20, it is possible to properly control the operations of the actuators 42, 44, 46 so that the requests are reflected in the output of the engine.

### Fifth Embodiment

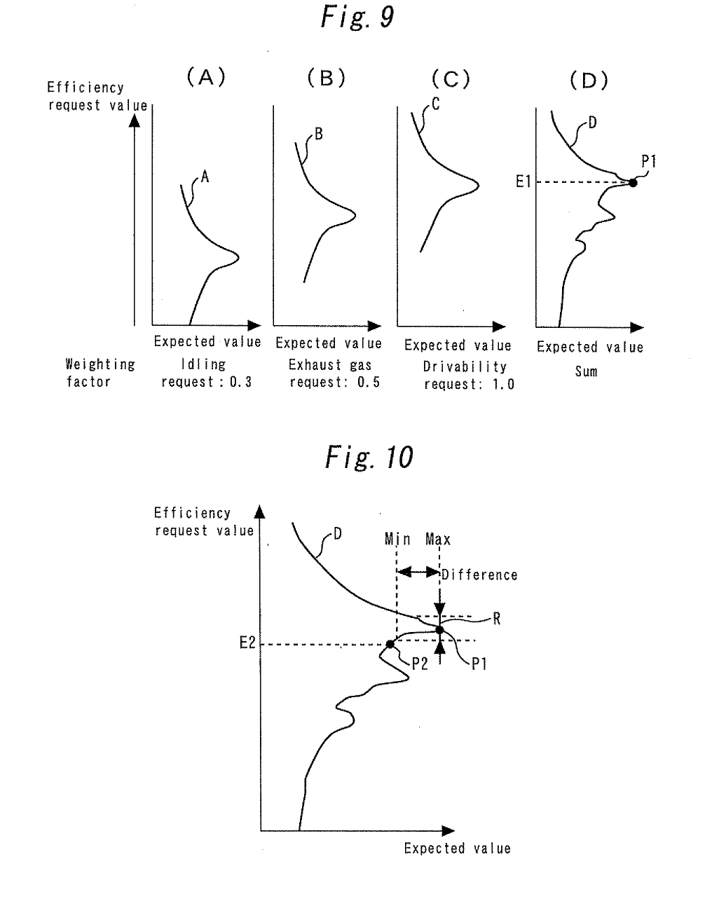

A fifth embodiment of the present invention will now be described with reference to FIGS. 9 to 11.

The configuration of the internal combustion engine control device according to the fifth embodiment of the present invention is depicted by the block diagram in FIG. 1 as is the case with the first embodiment. A typical efficiency request mediation process that the efficiency mediation element 24 of the mediation section 20 performs in accordance with the fifth embodiment will now be described with reference to FIGS. 9 and 10.

FIGS. 9 and 10 are diagrams illustrating an efficiency request mediation process that the efficiency mediation element 24 of the mediation section 20 performs in accordance with the fifth embodiment. More specifically, section (A) of FIG. 9 shows an efficiency request A output from the idling request output element 16 (hereinafter referred to as an “idling efficiency request”); and section (B) of FIG. 9 shows an efficiency request B output from the exhaust gas request output element 14 (hereinafter referred to as an “exhaust gas efficiency request”). Section (C) of FIG. 9 shows an efficiency request C output from the drivability request output element 12 (hereinafter referred to as a “drivability efficiency request”); and section (D) of FIG. 9 shows the sum D of the efficiency requests A, B, C, that is, a mediation result.

The efficiency requests A-C shown in FIG. 9 are defined on the basis of the range of request values and the distribution of expected values indicative of the degree of expectation of request values within the range. As regards the efficiency requests A-C, a request value having a great expected value is more important than a request value having a small expected value.

### [Idling Efficiency Request]

Combustion can be stabilized during idling by retarding the ignition timing from the MBT. It is therefore preferred that the efficiency be lowered. It is also preferred that the efficiency be lowered during idling so as to rapidly increase the torque to avoid a stall when the engine speed drastically decreases due to disturbance. However, if the efficiency is excessively lowered, combustion may deteriorate. In view of these circumstances, the idling request output element 16 outputs an idling efficiency request A as indicated in section (A) of FIG. 9.

### [Exhaust Gas Efficiency Request]

For catalyst warm-up, it is preferred that the ignition timing be retarded to after-burn fuel for the purpose of raising the exhaust temperature. However, if the efficiency is excessively lowered, the catalyst temperature may excessively rise (OT). Further, an efficiency decrease request may be generated to suppress in-cylinder combustion for NOx reduction. In view of these circumstances, the exhaust gas request output element 14 outputs an exhaust gas efficiency request B as indicated in section (B) of FIG. 9.

### [Drivability Efficiency Request]

As regards drivability, it is infrequently demanded that a torque increase request be instantly complied with. As indicated in section (C) of FIG. 9, therefore, the drivability efficiency request C, which is output from the drivability request output element 12, generally exhibits a higher request value than the efficiency requests A, B shown in sections (A) and (B) of FIG. 9.

As shown in FIG. 1, these efficiency requests A-C are collected by the efficiency mediation element 24 of the mediation section 20. The efficiency mediation element 24 adds up the efficiency requests A-C. More specifically, the expected values of the efficiency requests A-C are added up within a request value range of 0 to 1. Weighting factors preselected for the efficiency requests A-C are reflected in the addition of the expected values. As shown in FIG. 9, the weighting factor setting is 0.3 for the idling efficiency request A, 0.5 for the exhaust gas efficiency request B, and 1.0 for the drivability efficiency request C. When values obtained by multiplying the expected values of the efficiency requests A-C by the weighting factors are added together, the sum D of the expected values is obtained as shown in section (D) of FIG. 9.

Then, mediation could be conducted to determine a request value E1 that prevails when the sum D of the expected values is maximized (refer to section (D) of FIG. 9). More specifically, the efficiency request value E, which prevails when the sum D of the expected values is maximized, could be selected as a mediation result.

Meanwhile, an error may occur between an actual control result (actual value) and a mediation result (target value) due to performance and control variations among the actuators 42, 44, 46, which are used to produce a mediation result. The occurrence of such an error may render the mediation result meaningless or considerably decrease the degree of fulfillment of a plurality of requests output from the request output section 10.

In view of the above circumstances, the fifth embodiment considers the amount of change in the sum D within a fixed range R as well as the magnitude of the sum D, as described below, instead of unconditionally selecting as a mediation result the efficiency request value prevailing when the sum D is maximized.

First of all, a point P at which the sum D is maximized is searched for. When, for instance, point P1 is located as shown in FIG. 10, the maximum value Max and minimum value Min of the sum D are acquired within a fixed range R near the located point P1. More specifically, the maximum value Max and minimum value Min within the fixed range R whose center is indicated by the located point P1 are acquired. Then, the difference between the acquired maximum value Max and minimum value Min is calculated. In other words, the amount of change in the sum D within the fixed range R near the located point P1 is calculated.

If the calculated difference (change amount) is greater than a predetermined reference value, it is concluded that the degree of fulfillment of a plurality of requests may be considerably decreased by an error that may occur between a mediation result and an actual control result. In other words, if the actual control result deviates from the mediation result due to performance and control variations among the actuators 42, 44, 46, it is judged that the degree of fulfillment of the plurality of requests may greatly decrease. In this instance, another point P is searched for without selecting a request value corresponding to the located point P1 as a mediation result. In other words, a point P at which the sum D is subsequently maximized is located. Then, the same process as described above is performed on the located point P. More specifically, a point P at which the amount of change in the sum D within the fixed range R near the located point P is not greater than the reference value and is maximized is continuously searched for.

When the point P is to be searched for, the search may be started by sequentially locating peaks of the waveform of the sum D in order from the highest to the lowest. In other words, the peaks may be searched for to locate the point P prior to the search of a valley between the peaks of the sum D.

If, for instance, the amount of change in the sum D within the fixed range R near the located point P2 shown in FIG. 10 is not greater than the reference value, the central point P of the fixed range R is hereinafter referred to as a “specific point” when the amount of change in the sum D within the fixed range R is not greater than the reference value. Although the sum D has a plurality of specific points, the located point P2 is the maximum specific point. The amount of change in the sum D is small in the vicinity of the maximum specific point P2. Therefore, even when an error occurs between a mediation result and an actual control result due to performance and control variations among the actuators 42, 44, 46, it is possible to avoid a significant decrease in the degree of fulfillment of a plurality of requests. In the fifth embodiment, the efficiency request value E2 corresponding to the located point P2, which is the maximum specific point, is selected as a mediation result.

The torque mediation element 22 and air-fuel ratio mediation element 26 perform the same process as described above although the detailed descriptions of concrete examples are omitted here. For example, the torque mediation element 22 collects a drivability torque request, which is output from the drivability request output element 12, and the other torque requests (pre-fuel-cut torque request, fuel cut recovery torque request, etc.), which are not shown, and calculates the sum of the expected values of the requests in which the weighting factors are reflected. Further, if the central point of the fixed range R is handled as a specific point when the amount of change in the sum within the fixed range R is not greater than the reference value, the torque request value corresponding to the maximum specific point is selected as a mediation result. For example, the air-fuel ratio mediation element 26 collects a drivability air-fuel ratio request and an idling air-fuel ratio request, and calculates the sum of the expected values of the requests in which the weighting factors are reflected. Further, if the central point of the fixed range R is handled as a specific point when the amount of change in the sum within the fixed range R is not greater than the reference value, the air-fuel ratio request value corresponding to the maximum specific point is selected as a mediation result.

### [Details of Process Performed by Fifth Embodiment]

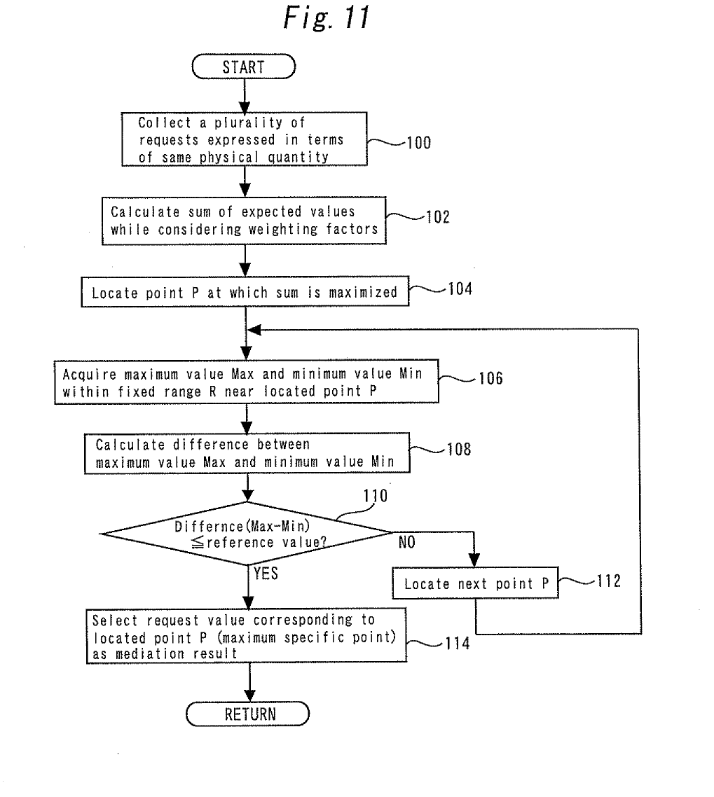

FIG. 11 is a flowchart illustrating a routine that the mediation section 20 executes in accordance with the fifth embodiment. The routine is started at predetermined time intervals.

First of all, the routine shown in FIG. 11 performs step 100 to collect a plurality of requests expressed in terms of the same physical quantity. Step 100 is performed to collect, for instance, an idling efficiency request A shown in section (A) of FIG. 9, an exhaust gas efficiency request B shown in section (B) of FIG. 9, and a drivability efficiency request C shown in section (C) of FIG. 9.

Next, step 102 is performed to calculate the sum of expected values with consideration given to the weighting factors. In step 102, the expected values that are multiplied by the weighting factors of the requests are added up. For example, the expected value of the idling efficiency request A, which is multiplied by a weighting factor of 0.3, the expected value of the exhaust gas efficiency request B, which is multiplied by a weighting factor of 0.5, and the expected value of the drivability efficiency request C, which is multiplied by a weighting factor of 1.0, are added up. Upon completion of step 102, for example, the sum D shown in section (D) of FIG. 9 is obtained.

Next, step 104 is performed to search for a point P at which the sum is maximized. In step 104, for example, a point P1 shown in FIG. 10 is located. Step 106 is then performed to acquire the maximum value Max and minimum value Min within the fixed range R near the located point P1. In step 106, for example, the maximum value Max and minimum value Min shown in FIG. 10 are acquired.

Next, step 108 is performed to calculate the difference between the maximum value Max and minimum value. Min that were acquired in step 106 above. In step 108, the amount of change in the sum within the fixed range R is calculated. Step 110 is then performed to judge whether the difference (change amount) calculated in step 108 above is not greater than the reference value. More specifically, step 110 is performed to judge whether the currently located point P is the maximum specific point.

If the judgment result obtained in step 110 indicates that the difference is greater than the reference value, it is concluded that the amount of change in the sum within the fixed range R near the located point P1 is large. In this instance, it is concluded that the degree of fulfillment of the plurality of requests output from the request output section 10 may considerably decrease due to an error between an actual control result and a mediation result. Step 112 is then performed to search for a point P at which the sum D is maximized again without selecting the request value corresponding to the located point P1 as a mediation result. Subsequently, the routine returns to step 106.

Step 106 is performed to acquire the maximum value Max and minimum value Min within the fixed range R near the located point P determined in step 112. Step 108 is then performed to calculate the difference between the maximum value Max and minimum value Min. Next, step 110 is performed to judge again whether the calculated difference is not greater than the reference value. A sequence of the above steps (steps 110, 106, and 108) is repeatedly performed until the difference is not greater than the reference value.

If, for instance, the point P2 shown in FIG. 10 is located in step 112, it is then found in step 110 that the difference is not greater than the reference value. More specifically, it is judged that the currently located point P2 is the maximum specific point. Thus, the amount of change in the sum within the fixed range R near the located point P2 is small. Therefore, it is concluded that a significant decrease in the degree of fulfillment of a plurality of requests output from the request output section 10 can be avoided even when an error occurs between the control result and mediation result. In this instance, step 112 is performed to select as a mediation result the efficiency request value corresponding to the located point P that is the maximum specific point. In the example shown in FIG. 10, the efficiency request value E2 corresponding to the located point P2, which is the maximum specific point, is selected as a mediation result. Subsequently, the routine terminates.

As described above, the fifth embodiment determines specific points, which are located points P at which the amount of change in the sum within the fixed range R near the located points P is not greater than the reference value, and conducts mediation to determine one request value corresponding to the maximum specific point. Therefore, even when an error occurs between an actual control result (actual value) and a mediation result (target value) due to performance and control variations among the actuators 42, 44, 46, it is possible to avoid a significant decrease in the degree of fulfillment of a plurality of requests output from the request output section 10.

Further, the weighting factors, which are considered during mediation, are set for the requests output from the request output section 10. The mediation elements 22, 24, 26 calculate the sum of expected values multiplied by the weighting factors. Therefore, the expected values of the plurality of requests expressed in terms of the same physical quantity can be properly reflected in the sum.

Meanwhile, the routine shown in FIG. 11 determines the maximum specific point from the points P at which the sum is maximized. However, an alternative method may be used to determine the maximum specific point. For example, an alternative would be to determine the maximum specific point from points at which the sum is minimized or to select the maximum specific point after determining all specific points from the sum (this is also true of a later-described sixth embodiment and seventh embodiment).

### Sixth Embodiment

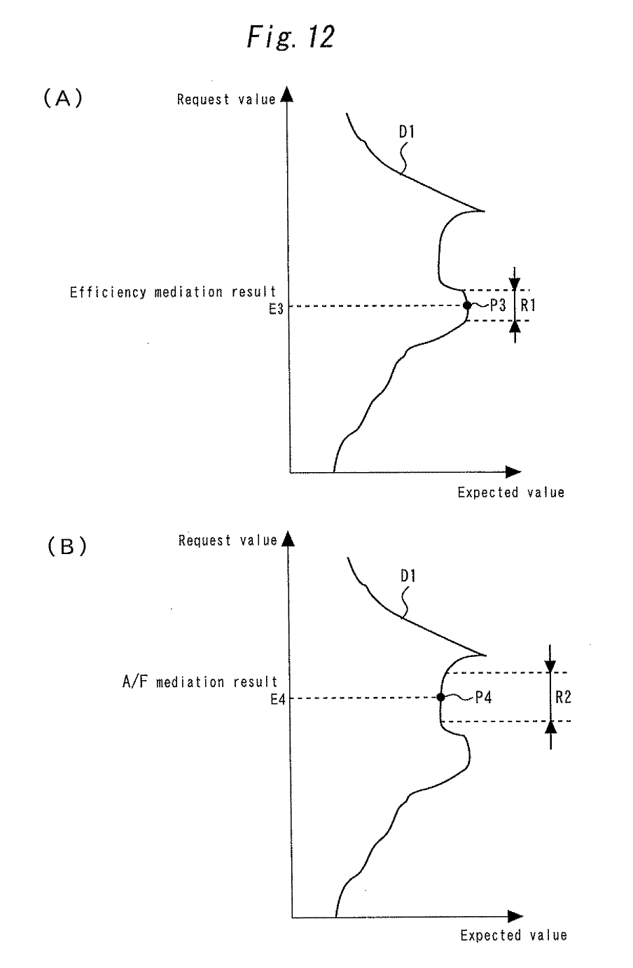

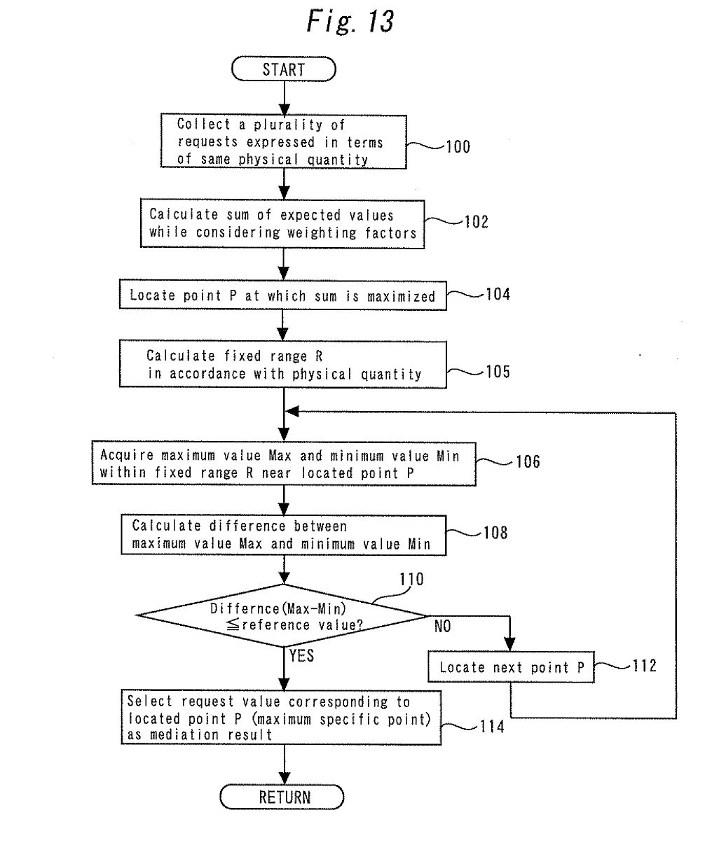

A sixth embodiment of the present invention will now be described with reference to FIGS. 12 and 13.

The fifth embodiment, which has been described above, determines specific points, which are located points P at which the amount of change in the sum D within a fixed range R near the located points P is not greater than a reference value, and selects as a mediation result the request value corresponding to the maximum specific point P. When calculating the amount of change in the sum D during mediation, the fifth embodiment uses the common fixed range R without regard to the type of physical quantity.

Meanwhile, the actuators 42, 44, 46 to be used vary with the type of physical quantity. Then, there are different performance variations and control variations among the actuators 42, 44, 46. Therefore, there are different actual control result variations from a mediation result. Consequently, the error between an actual control result and a mediation result also varies with the type of physical quantity.

In view of the above circumstances, the sixth embodiment calculates a fixed range R in accordance with the type of physical quantity. In other words, the fixed range R varies with the actuators 42, 44, 46 that are used to provide physical quantity control. More specifically, the higher the controllability of mainly used actuators 42, 44, 46, the smaller the setting for the fixed range R. In order of decreasing controllability, the actuators are the fuel injection device (fuel injection valve) 46 for air-fuel ratio control, the throttle valve 42 for torque control, and the ignition device (ignition plug) 46 for efficiency control. Therefore, named in order of increasing fixed range R calculated by the sixth embodiment are air-fuel ratio mediation, torque mediation, and efficiency mediation.

FIG. 12 relates to the sixth embodiment, and shows fixed ranges R, which are calculated during mediation, and mediation results. More specifically, section (A) of FIG. 12 shows a fixed range R1, which is calculated when efficiency mediation is conducted in accordance with a sum D1, and an efficiency mediation result E3, whereas section (B) of FIG. 12, shows a fixed range R2, which is calculated when air-fuel ratio mediation is conducted in accordance with the same sum D1 as indicated in section (A) of FIG. 12, and an air-fuel ratio mediation result E4.

During efficiency mediation, a relatively small fixed range R1 is calculated as shown in section (A) of FIG. 12. Then, the amount of change in the sum within the fixed range R1 near a located point P is calculated. Further, a located point P at which the amount of change in the sum is not greater than a reference value is regarded as a specific point. Finally, an efficiency request value corresponding to the maximum specific point, which is a located point P, is selected as a mediation result. In the example shown in section (A) of FIG. 12, an efficiency request value E3 corresponding to a located point P3, which is the maximum specific point, is selected as an efficiency mediation result.

During air-fuel ratio mediation, on the other hand, a fixed range R2 larger than the fixed range R1 is calculated as shown in section (B) of FIG. 12. Then, the amount of change in the sum within the fixed range R2 near a located point P is calculated. Further, a located point P at which the amount of change in the sum is not greater than a reference value is regarded as a specific point. Finally, an air-fuel ratio request value corresponding to the maximum specific point, which is a located point P, is selected as a mediation result. In the example shown in section (B) of FIG. 12, an air-fuel ratio request value E4 corresponding to a located point P4, which is the maximum specific point, is selected as an air-fuel ratio mediation result.

As described above, even when mediation is to be conducted on the basis of the same sum D1, the mediation result varies as far as the fixed range R varies with the physical quantity subjected to mediation. In other words, when the controllability of the actuator used for physical quantity control is high, a request value based on a higher sum (expected value) is obtained by mediation as far as the calculated fixed range R is small. In the example shown in FIG. 12, when the calculated fixed range R1 for efficiency mediation is smaller than the calculated fixed range R2 for air-fuel ratio mediation, the sum for the efficiency mediation result E4 is higher than the sum for the air-fuel ratio mediation result E3. Therefore, when mediation is conducted for a physical quantity related to an actuator used exhibiting high controllability, a request value based on a higher sum is obtained by mediation as far as the fixed range is relatively small.

### [Details of Process Performed by Sixth Embodiment]

FIG. 13 is a flowchart illustrating a routine that the mediation section 20 executes in accordance with the sixth embodiment. The routine is started at predetermined time intervals. The routine shown in FIG. 13 includes step 105 between steps 104 and 106 of the routine shown in FIG. 11. Therefore, the subsequent description is mainly focused on step 105.

In the same manner as for the routine shown in FIG. 11, the routine shown in FIG. 13 collects a plurality of requests expressed in terms of the same physical quantity (step 100), calculates the sum of expected values of the collected requests with consideration given to weighting factors (step 102), and locates a point P at which the sum is maximized (step 104).

Next, step 105 is performed to calculate a fixed range R in accordance with a physical quantity that is common to the collected requests. A plurality of fixed ranges (e.g., fixed ranges R1 and R2 in FIG. 12), which respectively correspond to a plurality of physical quantities (torque, efficiency, and air-fuel ratio), are stored beforehand in the mediation section 20. In step 105, a fixed range according to a physical quantity is read and used as the fixed range R.

An alternative would be to store a plurality of factors corresponding to the plurality of physical quantities in the mediation section 20 beforehand, read a factor corresponding to a physical quantity, multiply a basic fixed range by the factor, and use the resulting value as the fixed range R.

Next, step 106 is performed to acquire the maximum value Max and minimum value Min within the fixed range R calculated in step 105 near the located point P obtained in step 104. Subsequently, steps 108 and beyond are performed in the same manner as for the routine shown in FIG. 11.

In the sixth embodiment, the fixed range R within which the amount of change in the sum is calculated is calculated in accordance with a physical quantity, as described above. Thus, the actuators 42, 44, 46 to be used for request fulfillment vary with the type of physical quantity. Further, the accuracy of an actual control result varies with the type of physical quantity. Therefore, the magnitude of an error that may occur between an actual control result and a mediation result varies. Consequently, the fixed range R can be calculated with higher accuracy than when the type of physical quantity is disregarded during the calculation of the fixed range R. This makes it possible to further suppress a decrease in the degree of fulfillment of a request output from the request output section.

### Seventh Embodiment

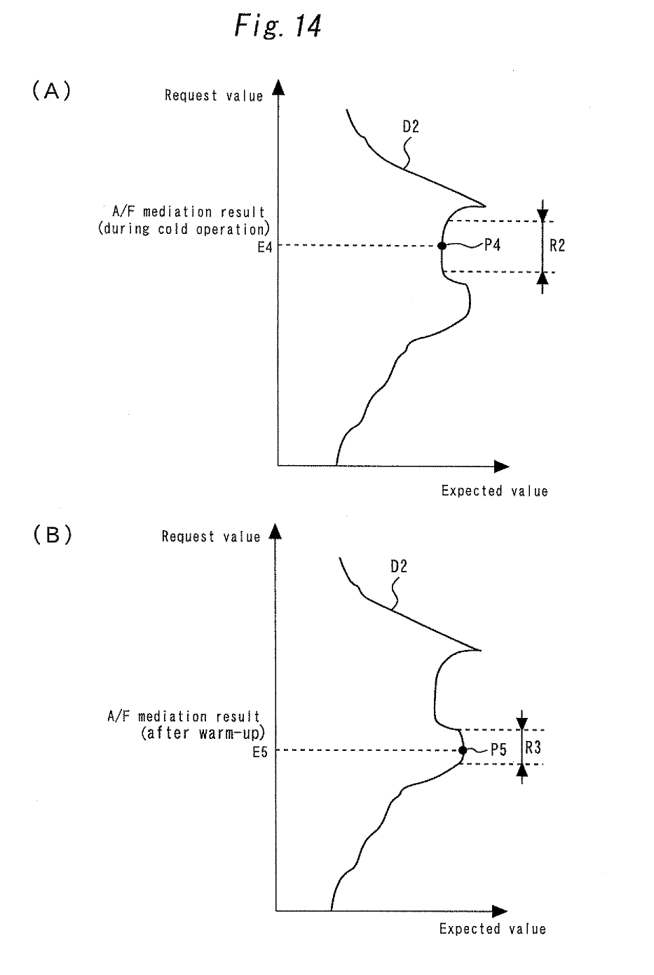

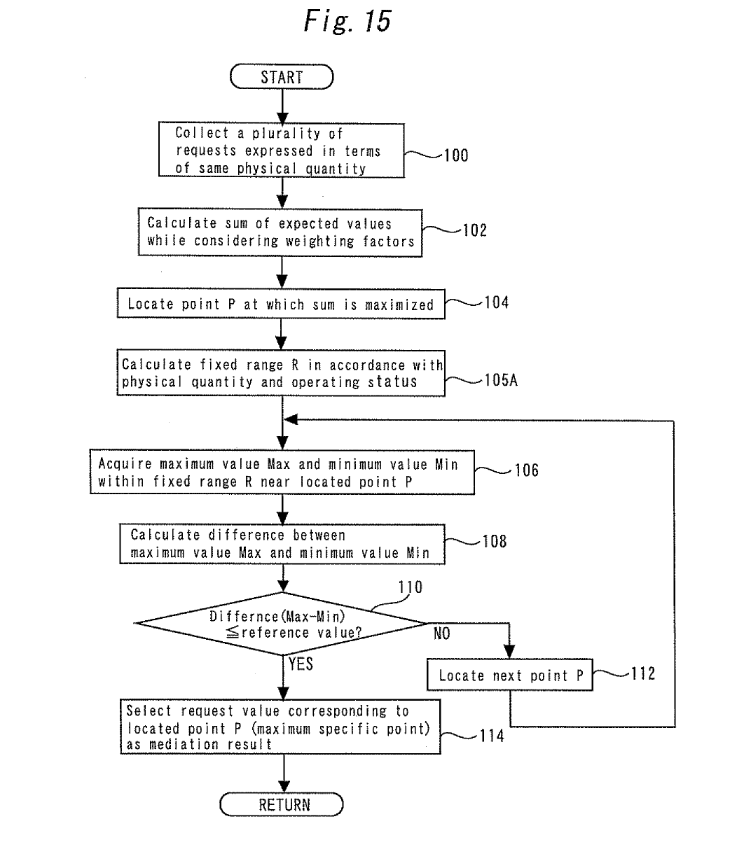

A seventh embodiment of the present invention will now be described with reference to FIGS. 14 and 15.

The sixth embodiment calculates the fixed range R in accordance with the type of physical quantity. Meanwhile, if the internal combustion engine operating status changes while the physical quantity remains unchanged, the error between a mediation result and an actual control result changes because actuator control variations change. For example, actuator control performance for producing an air-fuel ratio mediation result is higher during a post-warm-up operation during which the air-fuel ratio sensor is active (i.e., feedback control is exercised in accordance with an air-fuel ratio sensor output) than during a cold operation during which an air-fuel ratio sensor is inactive.

Further, a hydraulic variable valve mechanism may be used as an actuator in addition to the throttle valve 42 for the purpose of producing a torque mediation result. In such an instance, actuator control performance is higher during a post-warm-up operation during which hydraulic pressure is sufficiently high than during a cold operation during which hydraulic pressure is low.

In view of the above circumstances, the seventh embodiment sets the fixed range R in accordance with the type of physical quantity and the operating status of an internal combustion engine. More specifically, the seventh embodiment varies the fixed range R with consideration given not only to the type of physical quantity but also to actuator controllability according to the internal combustion engine operating status.

FIG. 14 relates to the seventh embodiment, and shows fixed ranges R, which are set during mediation, and mediation results. More specifically, section (A) of FIG. 14 shows a fixed range R2, which is calculated when air-fuel ratio mediation is conducted in accordance with a sum D2 during a cold operation, and an air-fuel ratio mediation result E4, whereas section (B) of FIG. 14 shows a fixed range R3, which is calculated when air-fuel ratio mediation is conducted after warm-up in accordance with the same sum D2 as indicated in section (A) of FIG. 14, and an air-fuel ratio mediation result E5.

When air-fuel ratio mediation is conducted during a cold operation, a relatively large fixed range R3 is calculated as shown in section (A) of FIG. 14. The reason is that actuator controllability is low during a cold operation because the air-fuel ratio sensor and oxygen sensor used for air-fuel ratio control are inactive. In this instance, therefore, an air-fuel ratio request value E4 corresponding to a located point P4, which is the maximum specific point, is selected as an air-fuel ratio mediation result.

When, on the other hand, air-fuel ratio mediation is conducted after warm-up, actuator controllability is higher than during a cold operation because, for instance, the air-fuel ratio sensor is active. In this instance, a fixed range R3 smaller than the fixed range R3 for a cold operation is calculated as shown in section (B) of FIG. 14. Then, a located point P5, which relates to a higher sum than the located point P4, becomes the maximum specific point. Consequently, an air-fuel ratio request value E5 corresponding to the located point P5 is selected as an air-fuel ratio mediation result.

Even if air-fuel ratio mediation is conducted on the basis of the same sum D2, the air-fuel ratio mediation result changes when the fixed range R is changed in accordance with the operating status. In other words, when an operation is conducted while actuator controllability is high, a request value based on a higher sum (expected value) is obtained by mediation as far as the calculated fixed range R is small.

### [Details of Process Performed by Seventh Embodiment]

FIG. 15 is a flowchart illustrating a routine that the mediation section 20 executes in accordance with the seventh embodiment. The routine is started at predetermined time intervals. The routine shown in FIG. 15 includes step 105A in place of step 105 of the routine shown in FIG. 13. Therefore, the subsequent description is mainly focused on step 105A.

In the same manner as for the routine shown in FIG. 11, the routine shown in FIG. 15 collects a plurality of requests expressed in terms of the same physical quantity (step 100), calculates the sum of expected values of the collected requests with consideration given to weighting factors (step 102), and locates a point P at which the sum is maximized (step 104).

Next, step 105A is performed to calculate a fixed range R in accordance with a physical quantity common to the collected requests and with the operating status of the internal combustion engine. The operating status of the internal combustion engine can be obtained from the common engine information distributed from the common engine information distribution section 52 to the mediation section 20. A plurality of factors corresponding to a plurality of physical quantities and factors corresponding to engine operating states (e.g., air-fuel ratio sensor activity and inactivity) are stored beforehand in the mediation section 20. In step 105A, a factor corresponding to a physical quantity and a factor corresponding to an engine operating state are read and multiplied by a basic fixed range to determine the fixed range R.

Next, step 106 is performed to acquire the maximum value Max and minimum value Min within the fixed range R calculated in step 105A near the located point P obtained in step 104. Subsequently, steps 108 and beyond are performed in the same manner as for the routine shown in FIG. 11.

As described above, the seventh embodiment calculates the fixed range R, which is used to calculate the amount of change in the sum, in accordance with the physical quantity and engine operating status. Even if the same physical quantity is used, actuator controllability varies with the engine operating status. Thus, the accuracy of an actual control result varies to vary the magnitude of an error that may occur between the actual control result and mediation result. Consequently, the fixed range R can be calculated with higher accuracy than when the type of physical quantity and the engine operating status are disregarded during the calculation of the fixed range R. This makes it possible to further suppress a decrease in the degree of fulfillment of a request output from the request output section.

### ADVANTAGES OF THE INVENTION

As is obvious from the foregoing description of the first to seventh embodiments, the present invention provides the advantages described below.

According to one aspect of the present invention, individual requests are defined by the range of request values and the distribution of expected values indicative of the degree of expectation of request values within the range. Since the importance of each request value can be expressed by the distribution of expected values within a request value range, even a low priority request value of relatively low importance can be reflected as appropriate in mediation as far as mediation is conducted in accordance with the expected values of each request.

According to another aspect of the present invention, the sum of expected values of a plurality of requests expressed in terms of the same physical quantity is calculated to determine by mediation a request value that prevails when the sum is maximized. Therefore, the sum derived from the requests reflects not only a request value of relatively high importance but also a request value of relatively low importance.

According to another aspect of the present invention, each request is assigned a weight that is taken into consideration during mediation. The mediation section calculates the sum of expected values with consideration given to the weight. This makes it possible to properly calculate the expected values of a plurality of requests expressed in terms of the same physical quantity.

According to another aspect of the present invention, individual requests are treated in such a manner that they are equal in the sum of expected values within the request value range. Therefore, the plurality of requests expressed in terms of the same physical quantity are equally handled before weights are considered. Consequently, the weights can be properly reflected in the calculation of the sum. This makes it possible to conduct proper mediation.

According to another aspect of the present invention, when an expected value of a request is greater than a predetermined upper limit value, the sum is calculated by using the upper limit value instead of the expected value. If, for instance, the request value range becomes narrow due to the operating status of an internal combustion engine, the expected value may be greater than the predetermined upper limit value. As a result, the weights assigned to requests may become meaningless although individual requests are made equal in the sum of expected values within the request value range. The feature described here prevents the expected values from exceeding the upper limit value. Therefore, the weights can be properly reflected in the calculation of the sum.

According to another aspect of the present invention, the weight that is considered during sum calculation is set in accordance with an operation mode. Therefore, when the operation mode is changed, the weight is also changed so that an optimum mediation result is obtained.

According to another aspect of the present invention, mediation is conducted for all of a plurality of operation modes while considering weights assigned to the individual operation modes. In other words, mediation is conducted for not only the current operation mode but also the other operation modes that can be selected later. Therefore, even if the operation mode suddenly changes, a mediation result can be instantly obtained.

According to another aspect of the present invention, when a mode change is to be made from a first operation mode to a second operation mode, the weight is gradually changed from a first weight to a second weight so that mediation is conducted while considering the gradually changed weight. This makes it possible to avoid a sudden change in the mediation result during an operation mode change. Therefore, it is possible to prevent the internal combustion engine status from changing suddenly.

According to another aspect of the present invention, when a mode change is to be made from the first operation mode to the second operation mode, the mediation result in which the first weight is reflected is compared against the mediation result in which the second weight is reflected. The comparison result is then used to determine whether or not to perform a gradual weight change process. This makes it possible to perform the gradual weight change process at appropriate timing. More specifically, the gradual weight change process can be performed in a situation where an operation mode change cause sudden change in the internal combustion engine status.

According to another aspect of the present invention, specific points, which are central points of a fixed range for making the amount of change in the sum within the fixed range not greater than a reference value, are obtained to conduct mediation for the purpose of determining a request value that corresponds to the maximum specific point. In other words, the amount of change in the sum is considered during mediation to consider the influence of an error that may occur between a request value, which is a mediation result, and an actual control result. Therefore, even when an error occurs between the mediation result and the actual control result, it is possible to avoid a significant decrease in the degree of fulfillment of a plurality of requests output from the request output section.

According to another aspect of the present invention, the fixed range is set in accordance with the type of physical quantity that is used to express a request. Thus, the actuators used for control vary with the type of physical quantity and the accuracy of an actual control result also varies with the type of physical quantity. This varies the magnitude of an error that may occur between a request value, which is a mediation result, and an actual control result. Consequently, the fixed range can be calculated with higher accuracy than when the type of physical quantity is not reflected in the fixed range. This makes it possible to further suppress a decrease in the degree of fulfillment of a request output from the request output section.

According to another aspect of the present invention, the fixed range is set in accordance not only with the type of physical quantity but also with the operating status of the internal combustion engine. Thus, the accuracy of an actual control result varies not only with the type of physical quantity but also with the operating status of the internal combustion engine. This varies the magnitude of an error that may occur between a mediation result and an actual control result. Consequently, the fixed range can be set with increased accuracy. This makes it possible to further suppress a decrease in the degree of fulfillment of a request output from the request output section.

According to still another aspect of the present invention, each request is assigned a weight that is taken into consideration during mediation. The mediation section calculates the sum of expected values with consideration given to the weight. Consequently, the expected values of a plurality of requests expressed in terms of the same physical quantity can be properly reflected in the sum.

1. An internal combustion engine control device comprising:
request output means which expresses a plurality of requests about functions of an internal combustion engine in terms of a physical quantity, defines individual requests on the basis of the range of request values and the distribution of expected values indicative of the degree of expectation of request values within the range, and outputs the defined requests; and
mediation means which collects a plurality of requests that are output from the request output means and expressed in terms of the same physical quantity, and conducts mediation in accordance with the expected values of the requests to determine one request value.

2. The internal combustion engine control device according to claim 1, wherein the mediation means calculates the sum of the expected values of the plurality of requests expressed in terms of the same physical quantity and conducts mediation to determine a request value that prevails when the sum is maximized.

3. The internal combustion engine control device according to claim 2, further comprising:
weight setup means which assigns to each request output from the request output means a weight that will be taken into consideration during mediation by the mediation means;
wherein the mediation means calculates the sum of expected values in which the weight assigned by the weight setup means is reflected.

4. The internal combustion engine control device according to claim 3, wherein the requests output from the request output means are equal in the sum of the expected values within the range of request values.

5. The internal combustion engine control device according to claim 3, wherein, when a predetermined upper limit value is exceeded by an expected value of a request output from the request output means, the mediation means calculates the sum by using the upper limit value instead of the expected value.

6. The internal combustion engine control device according to claim 3, wherein the weight setup means assigns a weight to each request in accordance with a plurality of operation modes of the internal combustion engine.

7. The internal combustion engine control device according to claim 6, wherein the mediation means conducts mediation for all of the plurality of operation modes while considering weights assigned to the individual operation modes.

8. The internal combustion engine control device according to claim 6, further comprising:
gradual change means which, when a mode change is to be made from a first operation mode to a second operation mode, performs a gradual change process by gradually changing the weight from a first weight defined for the first operation mode to a second weight defined for the second operation mode;
wherein the mediation means conducts mediation while considering the weight changed by the gradual change means.

9. The internal combustion engine control device according to claim 8, further comprising:
judgment means which, when a mode change is to be made from the first operation mode to the second operation mode, determines, in accordance with the result of comparison between a mediation result in which the first weight is reflected and a mediation result in which the second weight is reflected, whether or not to let the gradual change means perform a gradual change process.

10. The internal combustion engine control device according to claim 1, wherein the mediation means calculates the sum of expected values of a plurality of requests expressed in terms of the same physical quantity, determines specific points which are central points of a fixed range for making the amount of change in the sum within the fixed range not greater than a reference value, and conducts mediation to determine a request value that corresponds to the maximum specific point.

11. The internal combustion engine control device according to claim 10, wherein the mediation means sets the fixed range in accordance with the type of physical quantity.

12. The internal combustion engine control device according to claim 10, wherein the mediation means sets the fixed range in accordance not only with the type of physical quantity but also with the operating status of the internal combustion engine.

13. The internal combustion engine control device according to any one of claim 10, further comprising:
weight setup means which assigns to each request output from the request output means a weight that will be taken into consideration during mediation by the mediation means;
wherein the mediation means calculates the sum of expected values in which the weight assigned by the weight setup means is reflected.

14. An internal combustion engine control device comprising:
a request output section which expresses a plurality of requests about functions of an internal combustion engine in terms of a physical quantity, defines individual requests on the basis of the range of request values and the distribution of expected values indicative of the degree of expectation of request values within the range, and outputs the defined requests; and
a mediation section which collects a plurality of requests that are output from the request output section and expressed in terms of the same physical quantity, and conducts mediation in accordance with the expected values of the requests to determine one request value.
